(19) United States
(12) Patent Application Publication
(10) Pub. No.: US 2026/0170644 A1
(43) Pub. Date: Jun. 18, 2026

(54) METHOD AND DEVICE FOR GENERATING A RECORDING OF A SAMPLE IN A PREDETERMINED TARGET CONTRAST TYPE

(71) Applicant: Carl Zeiss Microscopy GmbH, Jena (DE)

(72) Inventors: Manuel Amthor, Jena (DE); Anselm Brachmann, Jena (DE); Alexander Freytag, Erfurt (DE); Daniel Haase, Zöllnitz (DE); Ingo Kleppe, Jena (DE); Stefan Leger, Dresden (DE); Lars Loetgering, Jena (DE); Markus Sticker, Jena (DE)

(73) Assignee: Carl Zeiss Microscopy GmbH, Jena (DE)

(21) Appl. No.: 19/411,495

(22) Filed: Dec. 8, 2025

(30) Foreign Application Priority Data
Dec. 16, 2024 (DE) 10 2024 138 145.0

(51) Int. Cl. G06T 7/00; G06T 5/70; G06T 7/11

(52) U.S. Cl. CPC G06T 7/0012; G06T 7/11; G06T 5/70; G06T 2207/10056; G06T 2207/20081

(57) ABSTRACT

Provided is a computer-implemented method for generating a second recording of a sample in a predetermined target contrast type, the method comprising detecting at least one structure using a segmentation algorithm, wherein the structure is contained in a first recording of the sample in a predetermined first input contrast type and should be visible in the second recording of the sample in the target contrast type, and generating the second recording of the sample in the target contrast type, the generation of the second recording in the target contrast type including determining first image intensity values of the first recording of the sample to generate the second recording based on the determined first image intensity values and the at least one structure detected in the first recording, wherein the predetermined target contrast corresponds to a microscopy contrast type.

### CROSS REFERENCE TO RELATED APPLICATION

This application claims priority to German patent application 10 2024 138 145.0 filed on Dec. 16, 2024, which is hereby incorporated by reference in its entirety.

### TECHNICAL FIELD

The disclosure can generally relate to field of image processing, optionally for microscopy recordings.

### BACKGROUND

Fluorescence recordings are used in various applications, for example in fluorescence microscopy.

Fluorescence microscopy is a specific form of light microscopy. If fluorescent substances are excited using light at specific wavelengths, they will emit light at different, longer wavelengths (this is known as the Stokes shift). Using the physical effect of fluorescence, recordings or images of a sample, which are referred to herein as fluorescence recordings, are recorded in fluorescence microscopy.

In fluorescence microscopy, the generated enlarged image of the examined object is generated exclusively by radiated or emitted light. Color filters prevent excitation light from reaching the image. Fluorescence microscopy images or fluorescence recordings are informative when only a few structures shine rather than the entire microscopic preparation fluorescing uniformly. These structures generate bright signals against a dark background.

Fluorescence-based color channels that image DNA dyes (e.g. 4′,6-diamidine-2-phenylindole, abbreviated DAPI, or Hoechst 33342) often serve as an orientation aid for the users in microscope images since this allows pose and state information for cells in the image region to be grasped quickly.

Even if other types of contrast are able to supply similar information in relation to the cells, users are often accustomed to fluorescence recordings (e.g. DAPI-like images) and prefer these over other contrast types.

However, the conventional generation of fluorescence recordings has some disadvantages. For example, the samples need to be stained, which in turn causes outlay and costs. Moreover, a fluorescence channel (usually 461 nm emission with DAPI) of the (recording) system is occupied by the fluorescence recording and cannot be used for other recordings. Furthermore, the sample may be damaged by the fluorescence recording process (e.g. as a result of what is known as phototoxicity or bleaching), whereby the duration of the entire experiment might also be adversely affected or lengthened. Furthermore, inaccuracies may occur in the case of e.g. DAPI staining should compounds sometimes not accumulate perfectly on the substance to be examined (this is known as “missed transfection”). This may lead to flawed DAPI recordings since portions of the sample appear non-active.

Ounkomol et al. (Ounkomol, C., Seshamani, S., Maleckar, M. M., Collman, F., & Johnson, G. R. (2018). Label-free prediction of three-dimensional fluorescence images from transmitted-light microscopy. Nature methods, 15(11), 917-920) describe what is known as virtual staining. Virtual staining refers to the determination of a “virtual” image representation of fluorescence staining, i.e. the fluorescence recording corresponding to a given recording of a sample is determined/calculated algorithmically. The calculation is implemented using data-driven artificial intelligence methods—for example trained deep neural networks—that are trained using fluorescence staining recordings as target values and inputs from a different recording modality. In this context, this calculated fluorescence image usually has the same intensity distribution as a real fluorescence recording, i.e. the same intensity gradations (e.g. int16 remains int16 and does not switch to a binary segmentation). However, the presence of these fluorescence gradations is often not sufficiently robust or cannot be implemented sufficiently reliably. For example, realistic images may be calculated but do not correspond to the true biology or chemistry. Furthermore, some of the employed models may not have sufficient generalization or extrapolation properties, especially in relation to samples previously not used during the training of the models. Furthermore, in some cases virtual staining may be unable to ensure sufficient retention of structure information regarding subcellular details (e.g. nucleoli).

DE 10 2021 114 287 A1 relates a computer-implemented method for generating an image processing model that generates output data which defines a stylized contrast image from a microscopy image. To this end, model parameters of the image processing model are adapted by optimizing at least one target function based on training data. The training data comprise microscopy images as input data and contrast images, with the microscopy images and contrast images being generated by different microscopy techniques. So that the output data define a stylized contrast image, a reduction in detail is forced by the target function, or the contrast images are reduced-detail contrast images that have a degree of detail which is lower than in the microscopy images and higher than in binary images.

WO 2021/198243 A1 relates to a method for virtual staining of a tissue sample, comprising selecting a virtual colorant, obtaining digital imaging data of the tissue sample, with the digital imaging data of the tissue sample having been acquired using one or more image modalities, determining a region of interest (ROI) of the tissue sample, and providing an output image that represents the tissue sample with the virtual colorant only in the ROI.

### SUMMARY

A computer-implemented method for generating a second recording of a sample in a predetermined target contrast type is provided. The method comprises detecting at least one structure using a segmentation algorithm, wherein the structure is contained in a first recording of the sample in a predetermined first input contrast type and should be visible in the second recording of the sample in the target contrast type, and generating the second recording of the sample in the target contrast type. The generation or generating of the second recording in the target contrast type includes determining first image intensity values of the first recording of the sample in the first input contrast type and/or second image intensity values of a third recording of the sample in a second input contrast type to generate the second recording of the sample in the target contrast type based on the determined first and/or second image intensity values and the at least one structure detected in the first recording, wherein the predetermined target contrast corresponds to a microscopy contrast type.

A computer-implemented training method for training a segmentation algorithm is provided. The training method comprises providing a training data record, the training data record including multiple training examples that each comprise a first recording of a sample in a first input contrast type and location information that relates to at least one structure which is contained in the first recording and which should be visible in a second recording of the sample in a target contrast type, with the first input contrast type optionally differing from the target contrast type, and training the segmentation algorithm using the training data record such that the segmentation algorithm post training is configured to detect a further structure which is contained in a further recording of a further sample in the first input contrast type and which should be visible in a further recording of the further sample in the target contrast type.

A computer-implemented method for producing a training data record for a segmentation algorithm is provided, the training data record including multiple training examples. The method comprises, for each training example, determining location information that relates to at least one structure that is contained in a first recording of a sample by virtue of using further location information that relates to the at least one structure and is obtained from a third recording of the sample in a second input contrast type, and annotating the first recording of the sample in the first input contrast type based on the determined location information that relates to the at least one structure contained in the first recording of the sample.

### BRIEF DESCRIPTION OF THE DRAWINGS

In the drawings:

FIG. 1 shows, schematically and by way of example, a flowchart of a computer-implemented method for generating a second recording of a sample in a target contrast type based on a recording of the sample in a first input contrast type,

FIG. 2 shows, schematically and by way of example, the recording of the sample in the first and second input contrast types and the second recording of the sample in the target contrast type,

FIG. 3 shows, schematically and by way of example, a segmentation result that is generated from the first or third recording using the segmentation algorithm, and

FIG. 4 shows, schematically and by way of example, a flowchart of a computer-implemented training method for training a segmentation algorithm that finds use in the method whose flowchart is depicted in FIG. 1.

### DESCRIPTION

In the following, details are set forth to provide a more thorough explanation of the disclosure. However, it will be apparent to those skilled in the art that these implementations may be practiced without these specific details. In other instances, well-known structures and devices are shown in block diagram form or in a schematic view rather than in detail to avoid obscuring the disclosure. In addition, features described hereinafter may be combined with each other, even if described with respect to different figures, unless specifically noted otherwise.

Equivalent or like elements or elements with equivalent or like functionality are denoted in the following description with equivalent or like reference numerals. As the same or functionally equivalent elements are given the equivalent or like reference numbers in the figures, a repeated description for elements provided with the equivalent or like reference numbers may be omitted. Hence, descriptions provided for elements having the equivalent or like reference numbers are mutually exchangeable.

Directional terminology, such as “top,” “bottom,” “below,” “above,” “front,” “behind,” “back,” “leading,” “trailing,” etc., may be used with reference to the orientation of the figures being described. Because parts of the disclosure, described herein, can be positioned in a number of different orientations, the directional terminology is used for purposes of illustration and is in no way limiting. It is to be understood that other implementations may be utilized, and structural or logical changes may be made without departing from the scope defined by the claims. The following detailed description, therefore, is not to be taken in a limiting sense.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

In implementations described herein or shown in the drawings, any direct electrical connection or coupling, e.g., any connection or coupling without additional intervening elements, may also be implemented by an indirect connection or coupling, e.g., a connection or coupling with one or more additional intervening elements, or vice versa, as long as the general purpose of the connection or coupling, for example, to transmit a certain kind of signal or to transmit a certain kind of information, is essentially maintained. Features from different implementations may be combined to form further implementations. For example, variations or modifications described with respect to one of the implementations may also be applicable to other implementations unless noted to the contrary.

The terms “substantially” and “approximately” may be used herein to account for small manufacturing tolerances (e.g., within 5%) that are deemed acceptable in the industry without departing from the aspects of the implementations described herein. For example, a resistor with an approximate resistance value may practically have a resistance within 5% of that approximate resistance value.

In the present disclosure, expressions including ordinal numbers, such as “first”, “second”, and/or the like, may modify various elements. However, such elements are not limited by the above expressions. For example, the above expressions do not limit the sequence and/or importance of the elements. The above expressions are used merely for the purpose of distinguishing an element from the other elements. For example, a first box and a second box indicate different boxes, although both are boxes. For further example, a first element could be termed a second element, and similarly, a second element could also be termed a first element without departing from the scope of the present disclosure.

A possible object addressed by the present disclosure may be considered that of avoiding hallucinations when generating a (second) recording of a sample in a predetermined target contrast type based on a (first) recording of the sample in a predetermined (first) input contrast type. In other words, the recording in the target contrast type should only depict those structures in the target contrast that according to the recording in the input contrast type are actually present in the sample.

Accordingly, a computer-implemented method for generating a second recording of a sample in a predetermined target contrast type can be provided. The method comprises detecting at least one structure, which is contained in a first recording of the sample in a predetermined first input contrast type and which should be visible in the second recording of the sample in the target contrast type, using an appropriately configured segmentation algorithm. The method comprises generating the second recording of the sample in the target contrast type. The generation of the second recording in the target contrast type comprises determining first image intensity values of the first recording of the sample in the first input contrast type and/or second image intensity values of a third recording of the sample in a second input contrast type in order to generate the second recording of the sample in the target contrast type on the basis of the determined first and/or second image intensity values and the at least one structure detected in the first recording. The predetermined target contrast type corresponds to a microscopy contrast type.

In other words, a (microscopy) recording of the real world in a first (input) contrast type may be obtained in a first step.

A (learned) segmentation method may be used in a second step to segment (relevant) structures that are encompassed by the obtained recording and that would be visible in a second contrast type/the target contrast type (optionally in a fluorescence image and optionally of a correspondingly colored sample).

In a third step, an image (optionally a fluorescence-like image) may be generated based on the segmentation method output. To this end, a texture of the at least structure detected using the segmentation algorithm can be transferred into the second recording. Furthermore, image intensity values may be transferred into the second recording, e.g. pixel by pixel, from the first recording in the first input contrast type by using a predetermined transfer rule.

In microscopy, a contrast type may be understood to mean a combination of a used recording modality (e.g. fluorescence imaging) and a used sample treatment (e.g. coloring or a genetic modification). In this way, recording the treated sample allows the generation of an image in which (desired) parts of the sample are visually (easily) detectable, i.e. have a contrast vis-à-vis the remaining parts of the recording. For example, the same recording modality (e.g. fluorescence imaging/fluorescence recording) may lead to different contrast types for different sample treatments. Depending on the contrast type (e.g. in the case of multichannel fluorescence recordings), a recording may be implemented by a monochrome camera, i.e. mapped onto grayscale values, and optionally have a large bit depth. For visual observation, the recording may be displayed on an 8-bit RGB monitor. To this end, the monochrome recording may be displayed at a hue angle—e.g. displayed in the blue channel of an RGB image (as in the case of DAPI but with the other two-color channels also being conceivable). In this case, the grayscale value channel may be converted for the 8-bit display by scaling and clipping.

To the extent that the target contrast type is mentioned as corresponding to a (predetermined) microscopy contrast type, this should be understood to mean that the target contrast type is modeled on the microscopy contrast type or comes as close as possible to the latter without necessarily being identical. For example, the target contrast type may have the essential properties of the microscopy contrast type, for example selectivity of the sample. In this case, the target contrast type may have more in common with the microscopy contrast type than the input contrast type.

According to a possible configuration described herein as purely optional, the method may be used to generate a DAPI-like microscopy image, which may e.g. be used as an orientation aid during microscopy, from a phase contrast image. To this end, it is possible to obtain a phase contrast image of a sample comprising cells. Cell nuclei of the cells may be segmented in the phase contrast image. Then, the DAPI-like image or the DAPI-like microscopy image can be generated by virtue of a texture of the segmented cell nucleus regions being transferred from the phase contrast image to the image to be generated and the image intensity values of the phase contrast image being transformed (inverted, smoothed) and colored in DAPI-like fashion.

However, the determination and/or transfer of the image intensity values need not necessarily make exclusive use of the same recording of the sample that also serves as an input for the segmentation algorithm. Rather, in addition to that or in an alternative, a further recording in a different input contrast type may be used, with the image intensity values thereupon being determined therefrom. In other words, to determine the image intensity values that are used for coloring purposes in the second recording of the sample in the target contrast, it is also possible (i.e. in addition to that or in an alternative) to use the image intensity values of a third recording of the sample in a second input contrast type. Thus, it is conceivable that the image intensity values used for coloring the sample originate from a different recording and/or the same recording from which the structure was segmented.

That is to say, multiple source contrast images may also be used. For example, a phase contrast may be used as the first source contrast and a (very) noisy DAPI channel may be used as the second source contrast. In that case, the reconstruction or the generated second recording may be a DAPI-like image with high-resolution structure information and a better DAPI signal strength. Here, the highly or finely resolved structure may originate from the phase contrast image, i.e. from the first source contrast, and the fluorescence intensity may originate from the noisy DAPI channel, i.e. the second source contrast. In other words, the structures may be adopted from the phase contrast image, for example. The fluorescence intensity from the DAPI channel or the fluorescence recording may reproduce or set the intensity level (optionally with low pass filtering) of the structures in the generated image. It is at least possible to suppress the noise in the background, i.e. in the regions of the phase contrast image in which no structures were detected. In detail, a transfer rule for generating the recording from the two contrast images may be implemented as outlined below in a specific implementation (described here as non-limiting):

$$I\_new ( x , y ) = I\_seg ( x , y ) * I\_PC ( x , y ) * Lowpass ( I\_Fluo ) ( x , y ) / Max ( I\_Fluo ) \qquad ( 1 )$$

where:

| | |
|---|---|
| I_new(x, y) | // image/recording to be generated at the pixel coordinates |
| | x, y |
| I_PC(x, y) | // image in the first source contrast, e.g. phase contrast |
| | image/phase contrast recording, at the pixel coordinates x, y |
| I_Fluo(x, y) | // image in the second source contrast, e.g. fluorescence |
| | image/fluorescence recording, at the pixel coordinates x, y |
| I_seg(x, y) | // binary mask determined by segmentation of I_PC |
| Lowpass(I_{—} | // result of the low-pass filtering of the image in the second |
| Fluo)(x, y) | source contrast at the pixel coordinates x, y. |
| Max(I_{—} | // maximum image intensity of the image in the second |
| Fluo) | source contrast |

The method thus enables denoising of fluorescence recordings. As explained in detail below, the segmentation may optionally be implemented in both source contrast images, too.

It is conceivable that a coloration for the second recording of the sample in the target contrast type is determined based on the determined image intensity values.

That is to say, spatial information (texture, structure) may be retained from the first recording, but the underlying image intensities may be altered in the process. For example, this may encompass grayscale value transformations (e.g. inversion, linear transformation, gamma correction, histogram equalization, . . . ) and/or filter operations (e.g. smoothing, background addition, . . . ).

In other words, the texture of the segmented object regions may be transferred into a new image from the (optionally microscopy) recording, and the image intensity values may be processed to form a virtually colored (optionally fluorescence) recording (e.g. with DAPI staining or Hoechst 33342). That is to say, the texture of the segmented structure, e.g. cell nucleus regions, in the initial image, e.g. one or more phase contrast images, may be transferred into the new image or image to be generated. Moreover, the image intensity values from the original recording may be transformed (optionally DAPI-like or Hoechst 33342-like), optionally inverted and/or smoothed, and the virtual image may be colored accordingly.

This offers the advantage that hallucinations are avoided when generating the second recording of the sample in the predetermined target contrast type based on the first recording of the sample in the predetermined first input contrast type. In other words, the recording in the target contrast type only depicts those structures in the target contrast that according to the recording in the input contrast type are actually present in the sample.

A texture may be understood to mean a spatial arrangement and distribution of the (segmented) structure. In this case, “spatial” may refer both to a two-dimensional space, i.e. a two-dimensional image representation of a surface of the sample, and to a three-dimensional space, i.e. a three-dimensional image representation of the sample.

The image intensity value may also be referred to as grayscale value. The grayscale value may specify the brightness of an individual picture element or pixel. Thus, the image intensity value may specify how bright or dark the relevant object or the respective picture element appears to the human eye in the first recording in the first input contrast type. In other words, the grayscale value may represent the brightness or intensity value of an individual picture element.

Thereupon, the image intensity value determined for each picture element or pixel may be used to determine a color of a picture element located in the second recording in the target contrast type to be generated and corresponding to the picture element in the first recording of the sample in the first input contrast type.

DAPI staining or Hoechst 33342 staining may be used to color the second recording in the target contrast type. 4′,6-diamidine-2-phenylindole, DAPI for short, is a fluorescent dye that is used in fluorescence microscopy for labeling deoxyribonucleic acid (DNA). The fluorescent dye Hoechst 33342 (bisbenzimide) is also used in fluorescence microscopy for staining DNA. In the present case, an image intensity value may be assigned a color that would have arisen in the case of fluorescence recording of the sample using the fluorescent dye DAPI or Hoechst 33342. Thus (artificial) DAPI staining or Hoechst 33342 staining may be generated using the image intensity values.

A computer-implemented method may be understood to mean a method in which one step, multiple steps or all steps of the method are carried out at least in part by a computer or a device for data processing.

Insofar as an algorithm is discussed in the present case, it may be implemented in software and/or hardware. The software may be provided as software as a service (SaaS). SaaS may be understood to mean a cloud-based software model that supplies applications to end users, e.g. via an Internet browser.

A recording may be understood to mean a two-dimensional (2-D) or three-dimensional (3-D) image or image representation of a sample, i.e. of an object existing in the real world. The recording may also be a time series recording in 2-D (2-D+t results in 3-D data) or 3-D (3-D+t results in four-dimensional (4-D) data).

The first recording in the first input contrast type may be recorded by a sensor, optionally a microscope sensor. The same applies to the third recording in the second input contrast type described below. A recording in an input contrast type may be understood to mean both the direct result of optical imaging onto an (analog-to-digital) sensor and a recording that was processed or combined by calculation or edited (post-processed) after acquisition by the sensor (e.g. using software appropriately configured to this end).

A structure that is intended to be visible in a recording of the sample in the second contrast type may be understood to mean a predetermined structure or a structure of a predetermined type, for example a cell nucleus.

A predetermined structure may be understood to mean a structure that can be detected or is automatically detected by a segmentation algorithm configured or set up to this end. In other words, the configuration of the segmentation algorithm defines which structure is detected or which objects that form the structure (and hence are relevant) are detected. The relevant objects are regularly defined by the application. In the field of life sciences, these may be e.g. one or more cell nuclei, cell skeleton(s), cell organelle(s) and/or tissue. In the field of the material science, these may be e.g. components of a printed circuit board. In metrology, rock samples, semiconductors and/or rough surfaces may be examined.

The contrast may define or set the difference between bright and dark regions in an image or a recording. Insofar as a contrast type is mentioned in the present case, it may be the contrast of the respective recording, optionally of the predetermined structures, vis-à-vis the remaining parts of the respective recording.

The above-described method inter alia offers the advantage that no artifacts or hallucinations arise in the generated images since the texture thereof originates from real measured recordings, e.g. microscopy data. In detail, the structure relevant to the target contrast type may initially be extracted using a segmentation method from the original recording with the first input contrast type. The structure obtained thus may thereupon be used to generate the further image or the recording in the target contrast type without the (image) intensity distribution having to be taken directly from the original recording or being taken automatically on account of a ML model. Hence, it is possible to provide a robust method that serves to generate virtual recordings with a first contrast type or target contrast type and moreover makes do with little computational outlay. This can also prevent artifacts or hallucinations in the generated recordings. In other words, the method initially does not make use of a ML (machine learning) algorithm that is trained to convert the contrast of a given recording into a different contrast; instead, a relevant structure is extracted or segmented, and the second recording is thereupon generated by coloring the extracted structure and a background surrounding the structure in accordance with the (target) contrast to be obtained.

The method may comprise detecting at least one structure that is contained in the third recording of the sample and should be visible in the second recording of the sample in the target contrast type. This may be implemented using a further segmentation algorithm and/or the appropriately configured segmentation algorithm. Thus, the second recording of the sample in the target contrast type may additionally be generated based on the structure contained in the third recording of the sample. For example, this may enable a plausibility check for the at least one structure and/or the augmentation thereof, which is detected or segmented in the first recording.

The third recording may be available in a second input contrast type. The second input contrast type may be the same contrast type as the first input contrast type or a different input contrast type. The second input contrast type may substantially correspond to the target contrast type.

It is conceivable that second image intensity values are obtained from the third recording, in addition to the second or further structure information from the third recording or in an alternative.

Generating the second recording may comprise transferring the determined first and/or second image intensity values into the second recording using a predetermined transfer rule. Optionally, transferring the determined first (and/or second) image intensity values using the predetermined transfer rule may be implemented exclusively into the regions of the second recording in which the detected at least one structure is situated according to the segmentation of the first and/or the third recording.

The second recording may be colored in accordance with predetermined (or customary) coloring of the corresponding microscopy contrast type.

Coloring may also be referred to as the coloration or color representation.

In other words, the grayscale values contained in the grayscale value image may, for example, be adopted in a color channel of a multi-channel fluorescence image, and in that case the channel may be assigned a predetermined color (which is usually used for the corresponding microscopy contrast type). It is conceivable that this color corresponds to the observable or perceivable color of the sample in the microscope (e.g. blue as fluorescence emission for DAPI staining).

It is conceivable that the other or remaining regions of the second recording, in which the structure is not situated, have a brightness according to a predetermined value.

This value may be a grayscale value. In the case of a single-channel recording, this value may be derived or obtained directly from the recording. In the case of a multi-channel recording, this value may be determined inter alia as described below. In detail, in the case of an RGB color value described here by way of example, the grayscale value may be calculated using the formula:

$$Grayscale value = 0.299 \times red component + 0.587 \times green component + 0.114 \times blue component .$$

The result is a value that reproduces the brightness of the picture element independently of the colors. Now, this brightness of the picture element may be transferred into the second recording using a predetermined transfer rule, i.e. a further grayscale value may be determined, and this further grayscale value may be used for the same picture element in the second recording. Here, it is not necessary for all RGB channels to be used to determine the grayscale value; it is also conceivable that only the red component, the green component and/or the blue component is used. It is also conceivable that the transfer rule states that the grayscale value determined based on the red component, the green component and/or the blue component is transferred directly or unchanged into the second recording.

It is also conceivable that the color of the respective picture element in the second recording is determined by or depends on the grayscale value. Thus, it is conceivable that each grayscale value is assigned a color by way of a transfer rule. That is to say, the grayscale value or the image intensity values from the source image(s) may determine not only the contrast of the second recording to be generated but also the color of the individual picture elements therein.

The obtained first and/or the third recording of the sample can be a microscopy recording, an optionally two- or three-dimensional microscopy recording, optionally a phase contrast image, a phase gradient image, a differential interference contrast image, a bright field image, an oblique illumination, a dark field image, an image obtained using quantitative phase imaging, an image obtained using optical coherence microscopy, an image obtained using holography, an image obtained using angular illumination microscopy, an image obtained using transport of intensity estimation phase imaging and/or an image obtained using differential phase contrast.

The target contrast type of the second recording may correspond at least in part to a predetermined fluorescence contrast type, optionally at least in part to DAPI staining or Hoechst 33342 staining.

A coloration of the second recording may correspond at least in part to a coloration of a fluorescence recording, optionally corresponding at least in part to DAPI staining or Hoechst 33342 staining.

That is to say, the colors of the individual picture elements in the target contrast may at least in parts be similar to the colors that would have been obtained in the case of a fluorescence recording of the sample, optionally corresponding to DAPI staining or Hoechst 33342 staining. It is conceivable that the target contrast is more similar to the predetermined fluorescence contrast than the first and/or the second input contrast type. It is also conceivable that the target contrast is more similar to the second input contrast than the first input contrast.

It is conceivable that the first and/or the third recording is a fluorescence recording, optionally corresponding to DAPI staining or Hoechst 33342 staining.

The method may comprise a preprocessing of the first and/or third recording that is performed before the at least one structure contained in the first and/or third recording is detected. The preprocessing may comprise a shading correction, denoising, a deconvolution, a brightness correction, a normalization of geometric properties, a registration of a lateral offset and/or a conversion of the phase contrast image into a virtual dark field image.

Shading correction may be understood to mean that by the use of (software-based) image processing, effects that result from a non-uniform illumination during the recording of the first and/or the third recording are removed by calculation or removed. In other words, shading may be understood to mean a superimposed background signal which is independent of the sample but which represents a large-area artifact of the recording and which should be removed by the shading correction.

Noise may have both sample-dependent and sample-independent components. The noise may be undesirable because it represents a stochastic component of the recorded image or of the recorded recording that is superimposed on the structure to be segmented. For example, this may make accurate segmentation at object boundaries more difficult. In denoising, (software-based) image processing may be used to remove this noise by calculation or to remove this noise.

Due to the hardware, individual points of light might not only be imaged on individual pixels when a recording is recorded but might also be “smeared” by imaging optics-specifically convoluted with the point-spread function (PSF) of the system. Under the assumption that the characteristic of the optics is known, this process can be removed by calculation (deconvolved). This can improve the resolution of the recording.

Overexposure or underexposure may lead to relevant structures being visually distinguishable from the background or from other structures only with difficulty. An adaptation of the brightness (e.g. gamma correction) within the scope of a brightness correction is able to improve the differences in the recorded brightness ranges.

Microscopy images are often recorded in partial images and combined to form a large image. In so doing, an offset may arise at the boundaries of the partial images. This may be corrected by registering a lateral offset.

The normalization of geometric properties, for example to a mean size of the objects, may be advantageous, especially if a magnification factor is known.

The phase contrast image can be converted into a virtual dark-field image, wherein an apparently bright image is generated on a dark background by calculation.

The method may comprise recording the first and/or the third recording. The first and/or the third recording is optionally implemented at a single time in each case and/or as a time series recording.

In other words, the recording, e.g. a microscopy image, may be a 2-D or 3-D recording (for example a Z-stack). The recording may be acquired at a single time, i.e. this may relate to a single recorded image. However, the recording may also comprise multiple recordings or images. It is conceivable that the multiple images are recorded at different times (optionally in succession) as what is known as a time series recording, i.e. multiple recordings that were recorded over a period of time and optionally combined to form a time series recording. The method is not restricted to microscopy images but may be applied to all imaging methods. For example, the method is also applicable to scenarios in microsurgery.

A phase contrast image may be recorded in such a way that artificial contrast inversions exist around the at least one structure that is contained in the phase contrast image and visible in the recording of the sample in the second contrast type.

That is to say, the image recording may be influenced in such a way that a segmentation of relevant objects or of the structure is facilitated. To this end, for example, what are known as “halos” may be generated in the phase contrast around the structure, e.g. cell nuclei, and said halos represent an artificial contrast inversion in order thus to facilitate a segmentation.

Generating the virtual recording of the sample in the second contrast type may comprise generating a background component and/or adding noise to the virtual recording of the sample in the second contrast type.

That is to say, a background component may be generated and/or noise may be added to the image and/or the background in order to obtain a more realistic image impression.

The method may comprise performing a plausibility check, in which a plausibility of the at least one structure detected using the segmentation algorithm and/or the generated second recording of the sample in the target contrast type is checked based on predetermined criteria, optionally using a ML model.

In other words, a plausibility check for the generated output may be provided. To this end, the imaging result or the generated second recording or else even the intermediate step of the segmented structure or regions may be checked for plausibility in an automated manner. For example, if this relates to cell nuclear staining, a check may be carried out as to whether a shape and the internal structure of the cell nuclei are plausible. For example, this may be performed by a watchdog model (discriminator) trained for this purpose. In addition to that or in an alternative, conventional image processing may be used for evaluating or checking the shape, ellipticity, size of the segmentation masks, etc. Herein, “plausible” may mean that there is a determination as to whether predetermined values are located with a tolerance range.

Further, a computer-implemented training method for training a segmentation algorithm is provided. The training method comprises providing a training data record. The training data record comprises multiple training examples that each comprise a first recording of a sample in a first input contrast type and location information that relates to at least one structure which is contained in the first recording and which should be visible in a second recording of the sample in a target contrast type. The first input contrast type may differ from the target contrast type.

The training method comprises training the segmentation algorithm using the training data record such that the segmentation algorithm post training is configured to detect a further structure which is contained in a further recording of a further sample in the first input contrast type and which should be visible in a further recording of the further sample in the target contrast type.

A segmentation may be understood to mean a generation of regions that are connected in terms content by combining adjacent pixels or voxels according to a predetermined criterion. The segmentation may be realized as semantic segmentation by machine learning approaches (optional deep learning), for example using a convolutional neural network (CNN) and/or a transformer-based model. In addition to that or in an alternative, use can be made of an instance segmentation, an (object) detection and/or a point localization with a predefined ROI (region of interest).

Depending on the training example, the training method may comprise determining the location information that relates to the at least one structure contained in the first recording of the sample. To this end, use may be made of further location information that relates to the at least one structure that is obtained from a third recording of the sample in a second input contrast type. Depending on the training example, the training method may comprise annotating the first recordings of the sample in the first input contrast type based on the determined location information that relates to the at least one structure contained in the first recording.

Thus, a partly automated or fully automated generation of the annotations based on a further recording may be provided. In a more specific example, this may mean that the annotations of the phase contrast image are obtained in an automated manner or using an algorithm from fluorescence recordings. For example, cell nuclei masks may be generated on the basis of measured DAPI recordings (e.g. using conventional image processing by smoothing, thresholding methods and the subsequent detection of the object contour or contour of the structure). This is also referred to as chemical annotation. This can (at least partially) avoid a manual generation of the annotations, especially by way of a manual annotation of the object regions, in the recordings for training the segmentation algorithm.

Information relating to a spatial relationship of regions of the first recording of the sample in the first input contrast type and the third recording of the sample in the second input contrast type can be used to annotate the first recordings of the sample in the first input contrast type.

It may be advantageous if the fluorescence recordings and the input data have a known spatial relationship to one another, optionally correspond pixel-wise. For example, this may be generated by virtue of the recordings being recorded alternately along the same optical path. Otherwise, the recordings may be initially registered to determine their spatial relationship to one another. This subsequently facilitates the above-described automated generation of the annotations.

The description provided above in relation to the computer-implemented method for generating the virtual recording of the sample in the second contrast type also applies analogously to the training method and vice versa.

Furthermore, a method may be provided for producing a training data record for a segmentation algorithm. The training data record comprises multiple training examples. For each training example, the (production) method comprises determining location information that relates to at least one structure which is contained in a first recording of a sample using further location information that relates to the at least one structure and is obtained from a third recording of the sample in a second input contrast type. The (production) method comprises annotating the first recordings of the sample in the first input contrast type based on the determined location information that relates to the at least one structure contained in the first recording of the sample.

The description given above in relation to the method in each case also applies analogously to the production method, and vice versa.

A device for data processing is also provided. The device is configured to carry out the above-described computer-implemented method and/or the above-described computer-implemented training method and/or the above-described production method at least in part.

Powerful computing hardware is advantageous for the learning phase and for the subsequent application phase, for example by using graphics cards (GPUs), tensor processing units (TPUs) and/or similar accelerators.

The device for data processing may be a computer, which is at least in part of a recording device (e.g. of a microscope) that records recording(s). It is conceivable that the device for data processing is configured to control the recording device in such a way that the latter records the recording(s). It is conceivable that the device for data processing is configured to control the recording device based on a result of the method. In addition to that or in an alternative, the device for data processing may be arranged at a distance from the recording device and may be connected to the latter in wired and/or wireless fashion, e.g. via the Internet. In addition to that or in an alternative, the device for data processing may at least in part be part of a cluster, e.g. a local computing network. In addition to that or in an alternative, the device for data processing may at least in part be part of a cloud computing entity.

The description given above in relation to the method in each case also applies analogously to the device for data processing, and vice versa.

A computer program is also provided. The computer program comprises commands that, when the program is executed by the computer, prompt the latter to at least partially carry out the above-described computer-implemented method and/or the above-described computer-implemented training method and/or the above-described production method.

In this case, the computer program or the software may comprise the algorithm or the commands in the form of a program code that, when executed on a computing unit or computing device, carries out the aforementioned method.

The program code may be available in any desired type of code, optionally in a code that is suitable for processing, optionally for a controller, in a microscope.

What has been described above in relation to the methods and to the device for data processing also applies, in each case analogously, to the computer program, and vice versa.

A computer-readable medium is also provided. The computer-readable medium comprises commands that, when the commands are executed by a computer, prompt the latter to at least partially carry out the above-described computer-implemented method and/or the above-described computer-implemented training method and/or the above-described production method.

The computer-readable storage medium, which may comprise an above-defined computer program, may be any desired digital data storage apparatus, for example a USB stick, a hard disk, a CD-ROM, an SD card and/or an SSD card.

In addition to that or in an alternative, the computer program may also be obtained differently, e.g. via the Internet. Accordingly, the computer-readable medium may be a data signal comprising commands that, when the commands are executed by a computer, prompt the latter to at least partially carry out the above-described computer-implemented method and/or the above-described computer-implemented training method.

What has been described above in relation to the methods, to the device for data processing and to the computer program also applies, in each case analogously, to the computer-readable medium, and vice versa.

The same reference signs refer to the same or similar objects.

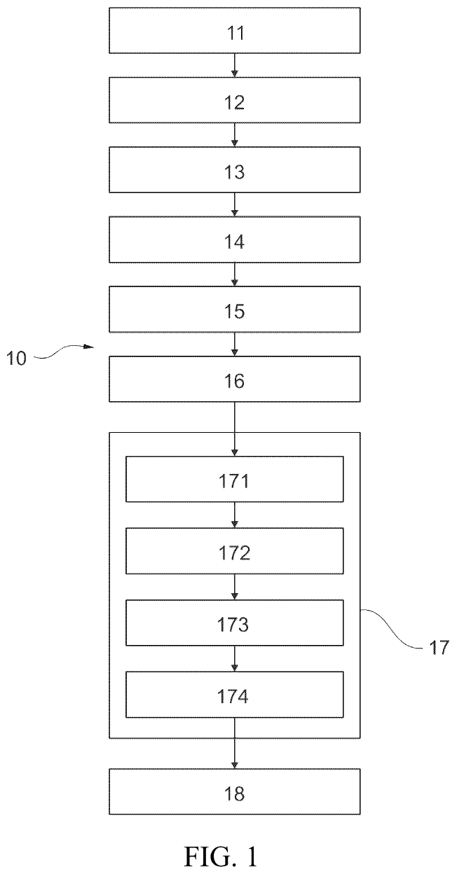

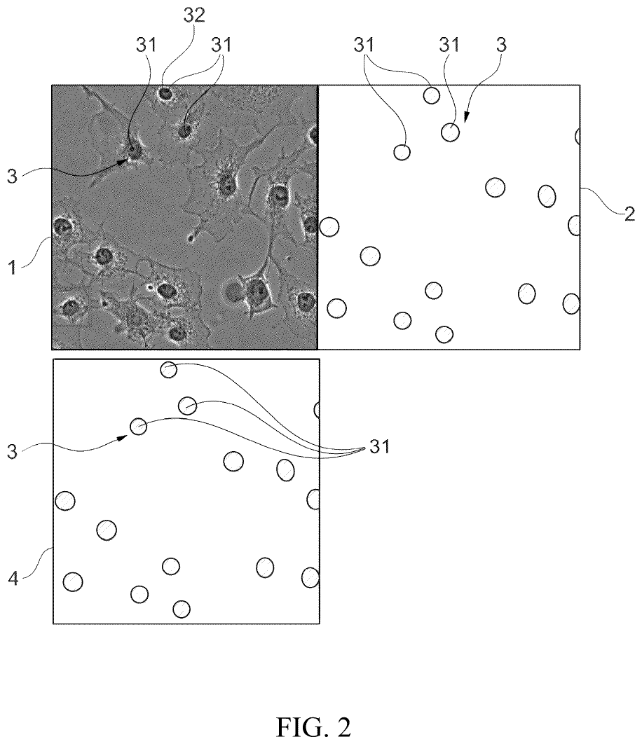

The computer-implemented method 10 for generating a second recording 2 of a sample in a target contrast type is described in detail below with reference to FIGS. 1 and 2.

A first recording 1 of the sample is recorded in a first input contrast type in a first step 11 of the method 10. Moreover, a third recording 4 of the sample is recorded in a second input contrast type, with the first input contrast type differing from the second input contrast type. Both recordings 1, 4 may be recorded using a microscope (not illustrated).

As evident from the left-hand side of FIG. 2, the first recording 1 in the present case is a two-dimensional phase contrast image 1. In the present case, the third image 4 is a two-dimensional (real) fluorescence recording. The second recording 2 of the sample in the target contrast type, as generated using the method 10, is depicted on the right-hand side in FIG. 2. This predetermined target contrast type corresponds to a microscopy contrast type. More precisely, the second recording 2 is a two-dimensional recording 2, the contrast of which is similar to that of a fluorescence recording. The second input contrast is therefore more similar to the target contrast than the first input contrast.

The same cell nuclei 31, which form the structure 3 relevant to the method 10 in the present case, are visible in the same spatial distribution in all three recordings 1, 2, 4.

The first recording 1 and/or the third recording 4 are each recorded at a single time or as a time series recording, i.e. both or one of the recordings 1, 4 may be obtained from multiple recordings that were recorded with a time offset (optionally in succession).

The first recording 1 is recorded in such a way that artificial or artificially generated contrast inversions 32 exist around the at least one structure 3 which is contained in the first recording 1 and should be visible in the second recording of the sample in the target contrast type.

In a second step 12 of the method 12, the first recording 1 recorded in the first step 11 is received at a device for data processing (not illustrated), which carries out the steps of the method 10 described below. It is conceivable that this device for data processing controls the first step 11.

In a third step 13 of the method 10 the third recording 4, which was also recorded in the first step 11, is also received at the device for data processing.

In a fourth step 14 of the method 10, the recordings 1, 4 obtained in the second and third step 12, 13, i.e. the recordings of the phase contrast image and/or of the fluorescence recording, are preprocessed using the appropriately configured device for data processing. The preprocessing comprises a shading correction, denoising, a deconvolution, a brightness correction, a normalization of geometric properties and/or a conversion of the phase contrast image, i.e. the first recording 1, into a virtual dark field image. The preprocessing is performed before the structure 3 contained in the phase contrast image 1 is detected.

In a fifth step 15 of the method 10, the structure 3 contained in the first recording 1 is detected using a (trained and learned) segmentation algorithm. In this case, the segmentation algorithm is trained in such a way that the latter detects a structure in the first recording 1 that should be visible in the second recording 2.

In a sixth step 16 of the method 10, at least one structure contained in the third recording 4 is detected by a segmentation algorithm or the segmentation algorithm. In the present case, the structure 3 detected in the third recording 4 is the same structure 3 that was also detected in the first recording 1. In other words, the structure 3 in the phase contrast image 1 that is also visible in the third recording 4 and is identified and detected there in the sixth step 16 is detected in the fifth step 15 of the method 10.

It is thus conceivable that the structure 3 or the structure information is also or additionally obtained from the third recording 4 using the same segmentation algorithm or a further correspondingly trained or configured segmentation algorithm. The structure 3 extracted from the third recording 4 may be compared with the structure 3 extracted from the first recording 1, e.g. to complement the structure 3 extracted from the first recording 1 and/or carry out a plausibility check.

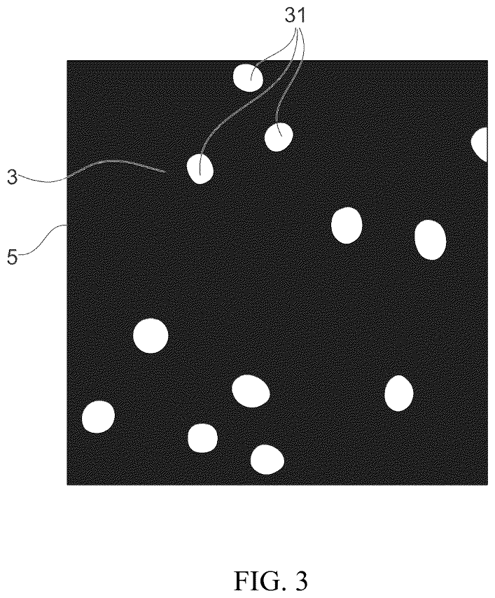

A segmentation result or a binary mask 5 resulting from the segmentation of the first and/or third recording 1, 4 is depicted by way of example in FIG. 3. Here, a binary segmentation has been performed, i.e. the parts of the first or the third recording 1, 4 that should be associated with the structure 3 have been assigned to the foreground and all the other parts of the first or third recording 1, 4 have been assigned to the background.

The second recording 2 is generated in a seventh step 17 of the method 10 based on the structure 3 detected in the first and/or third recording 1, 4 (in this respect, see FIG. 3) using the segmentation algorithm or algorithms.

To this end, a texture of the structure 3 detected in the phase contrast image 1 using the segmentation algorithm is transferred into an initial second recording in a first sub-step 171 of the seventh step 17. The initial second recording corresponds to the segmentation result 5 depicted in FIG. 3 and can be considered to be the output of the segmentation algorithm.

The image intensity values of the first and/or of the third recording 1, 4 are determined in a second sub-step 172 of the seventh step 17, optionally exclusively in the regions corresponding to the structure 3 detected therein (in each case). The second recording 2 is generated based on the determined image intensity values and the segmented structure 3, i.e. the texture or structure 3 contained in the initial second recording or the segmentation result 5 is colored based on the determined image intensity values. The coloration of the second recording is implemented in accordance with predetermined coloration of the corresponding microscopy contrast type, i.e. in a manner corresponding to DAPI staining in this case. This coloring may be implemented using a transfer rule that is chosen based on the target contrast and assigns a color and/or a brightness to a specific image intensity value.

In the third sub-step 173 of the seventh step 17, a background component may be added to the second recording 2 obtained in the second sub-step 2, i.e. a background component such as an (artificial) shading profile and/or structure(s) representing a sample holder may be inserted into the second recording 2. In addition to that or in an alternative, noise or background noise may be added to the second recording 2 in a fourth sub-step 174 of the seventh step 17.

A plausibility check is performed in an eighth step 18 of the method 10. In this case, a plausibility of the structure 3 in the first recording 1 and/or third recording 4 detected by the respective segmentation algorithm may be checked. In addition to that or in an alternative, a plausibility of the generated second recording 2 may be checked. In addition to that or in an alternative, a plausibility of the initial second recording 2 (see first sub-step 171 of the seventh step 17) may be checked. Predetermined criteria, for example in relation to a shape of the detected structure 3 and/or the structure generated in the (initial) second recording 2, may be used for the plausibility check. It is conceivable that the plausibility check uses a ML model (learned for this purpose).

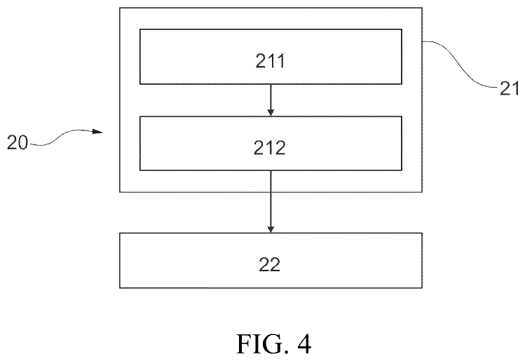

The computer-implemented training method 20, by which the segmentation algorithm used in the fifth step 15 of the method 10 for detecting the structure 3 contained in the first recording 1 can be trained, is described below. The description of the training method 20 with reference to the segmentation algorithm used in the fifth step 15 of the method 10 applies mutatis mutandis to the segmentation algorithm used in the sixth step 16 of the method 10, i.e. to the segmentation algorithm used to detect the structure 3 in the third recording 4. A flowchart of the training method 20 is illustrated by way of example in FIG. 4.

In a first step 21 of the training method 20, a training data record comprising multiple training examples is provided. The training examples each comprise a first recording 1 in a first input contrast (e.g. a phase contrast image) and location information that relates to at least one structure 3 which is contained in the first recording 1 and which should be visible in a second recording 2 of the sample in a target contrast type. The first input contrast type differs from the target contrast type.

In a first sub-step 211 of the first step 21, the provision of the training data record comprises determining the location information that relates to the at least one structure 3 contained in the first recording 1 of the sample. The location information may specify which pixels and/or picture elements or image regions in the first recording 1 should be assigned to the structure 3. The location information may be determined using further location information that relates to the at least one structure 3 obtained from a third recording 4 in a second input contrast (e.g. a fluorescence recording). In other words, the third recording 4 may already be available with annotations, and/or e.g. as described above in relation to the sixth step 16, the structure 3 in the third recording 4 may be detected using a segmentation algorithm. The pose of the structure 3 contained in the third recording 4 may thereupon be determined and provided as the further location information. For example, should information relating to a spatial relationship between regions in the first recording 1 and the associated third recording 4 be known (e.g. which pixel from the first recording 2 corresponds to which pixel from the third recording 4), this spatial relationship may be used to convert the further location information into the location information to be determined.

Thereupon, the first recording 1 may be annotated (automatically) in a second sub-step 212 of the first step 21 based on the determined location information.

The first and the second sub-steps 211, 212 may also be referred to as a computer-implemented method for producing the training data record for the segmentation algorithm.

The segmentation algorithm is trained using the training data record, more precisely using the annotated fluorescence recordings in the present case, in a second step 22 of the training method 20. Once the training has been completed, the segmentation algorithm is configured to detect a structure 3 in a further recording (i.e. a recording not contained in the training data record) in the first input contrast type that should be visible in a further second recording in the target contrast type.

### REFERENCE SYMBOLS

1 First recording of the sample in the first input contrast type
2 Second recording of the sample in the target contrast type
3 Structure
31 Cell nuclei
32 Contrast inversion
4 Third recording of the sample in the second input contrast type
5 Segmentation result or segmented first/third recording
10 Computer-implemented method
11 Recording the recording of the sample in the first/second contrast type
12 Obtaining the recording of the sample in the first contrast type
13 Obtaining the recording of the sample in the second contrast type
14 Preprocessing the recording of the sample in the first contrast type
15 Detecting at least one structure contained in the recording of the sample in the first contrast type
16 Detecting at least one structure contained in the recording of the sample in the second contrast type
17 Generating the virtual recording
171 Transferring a texture
172 Determining image intensity values
173 Generating a background component
174 Adding noise to the virtual recording of the sample
18 Performing a plausibility check
20 Computer-implemented training method
21 Providing a training data record
21 Detecting a structure contained in the recording of the sample in the second contrast type
212 Annotating the recordings of the sample in the first contrast type
22 Training the segmentation algorithm with the training data record

What is claimed is:

1. A computer-implemented method for generating a second recording of a sample in a predetermined target contrast type, the method comprising:
detecting at least one structure using a segmentation algorithm, wherein the structure is contained in a first recording of the sample in a predetermined first input contrast type and should be visible in the second recording of the sample in the target contrast type, and
generating the second recording of the sample in the target contrast type, the generating of the second recording in the target contrast type including:
determining first image intensity values of the first recording of the sample in the first input contrast type and/or second image intensity values of a third recording of the sample in a second input contrast type to generate the second recording of the sample in the target contrast type based on the determined first and/or second image intensity values and the at least one structure detected in the first recording,
wherein the predetermined target contrast corresponds to a microscopy contrast type.

2. The computer-implemented method according to claim 1, wherein the method comprises:
detecting at least one structure, which is contained in the third recording of the sample and which should be visible in the second recording of the sample in the target contrast type, using a further segmentation algorithm and/or the segmentation algorithm to additionally generate the second recording of the sample in the target contrast type based on the structure contained in the third recording of the sample.

3. The computer-implemented method according to claim 1, wherein the generation of the second recording includes:
transferring the determined first and/or second image intensity values into the second recording using a predetermined transfer rule, optionally exclusively into regions of the second recording in which the detected at least one structure is situated according to the segmentation of the first recording.

4. The computer-implemented method according to claim 1, wherein the second recording is colored according to a predetermined coloring of the corresponding microscopy contrast type.

5. The computer-implemented method according to claim 1, wherein:
the first recording and/or the third recording of the sample is a microscopy recording, optionally a two- or three-dimensional microscopy recording, further optionally a phase contrast image, a phase gradient image, a differential interference contrast image, a bright field image, an oblique illumination, a dark field image, an image obtained using quantitative phase imaging, an image obtained using optical coherence microscopy, an image obtained using holography, an image obtained using angular illumination microscopy, an image obtained using transport of intensity estimation phase imaging, and/or an image obtained using differential phase contrast,
the target contrast type of the second recording corresponds at least in part to a predetermined fluorescence contrast type, optionally at least in part to DAPI staining or Hoechst 33342 staining, and/or
the first and/or the third recording of the sample is a fluorescence recording, optionally corresponding to the DAPI staining or the Hoechst 33342 staining.

6. The computer-implemented method according to claim 1, wherein the method comprises preprocessing of the first recording and/or the third recording, which is performed before the detecting of the at least one structure contained in the first recording, the preprocessing optionally comprising:
a shading correction,
denoising,
a deconvolution,
a brightness correction, and/or
a normalization of geometric properties.

7. The computer-implemented method according to claim 1, wherein the method comprises recording the first recording and/or the third recording, with the recording of the first recording and/or the third recording optionally being implemented at a single time and/or as a time series recording, respectively.

8. The computer-implemented method according to claim 7, wherein the first recording and/or the third recording of the sample is a phase contrast image, wherein the phase contrast image is recorded in such a way that there is at least one artificial contrast inversion around the at least one structure which is contained in the phase contrast image and which should be visible in the second recording of the sample in the target contrast type.

9. The computer-implemented method according to claim 1, wherein the generating of the second recording of the sample in the target contrast type includes generating a background component and/or adding noise to the second recording of the sample in the target contrast type.

10. The computer-implemented method according to claim 1, wherein the method comprises performing a plausibility check, in which a plausibility of
the at least one structure detected using the segmentation algorithm and/or
the generated second recording of the sample in the target contrast type is checked based on predetermined criteria, optionally using a ML model.

11. A computer-implemented training method for training a segmentation algorithm, the training method comprising:
providing a training data record, the training data record including multiple training examples that each comprise a first recording of a sample in a first input contrast type and location information that relates to at least one structure which is contained in the first recording and which should be visible in a second recording of the sample in a target contrast type, with the first input contrast type optionally differing from the target contrast type, and
training the segmentation algorithm using the training data record such that segmentation algorithm post training is configured to detect a further structure which is contained in a further recording of a further sample in the first input contrast type and which should be visible in a further recording of the further sample in the target contrast type.

12. The computer-implemented training method according to claim 11, wherein for each training example, the training method comprises:
determining the location information that relates to the at least one structure which is contained in the first recording of the sample using further location information that relates to the at least one structure and is obtained from a third recording of the sample in a second input contrast type, and
annotating the first recordings of the sample in the first input contrast type based on the determined location information that relates to the at least one structure contained in the first recording.

13. The computer-implemented training method according to claim 12, wherein information relating to a spatial relationship of regions of the first recording of the sample in the first input contrast type and the third recording of the sample in the second input contrast type is used to annotate the first recordings of the sample in the first input contrast type.

14. A computer-implemented method for producing a training data record for a segmentation algorithm, the training data record including multiple training examples, wherein, for each training example, the training method comprises:
determining location information that relates to at least one structure that is contained in a first recording of a sample by virtue of using further location information that relates to the at least one structure and is obtained from a third recording of the sample in a second input contrast type, and
annotating the first recording of the sample in the first input contrast type based on the determined location information that relates to the at least one structure contained in the first recording of the sample.

15. A device for data processing, wherein the device comprises a processor and is configured to carry out the computer-implemented method according to claim 1.

16. A non-transitory computer-readable medium, wherein the computer-readable medium comprises commands that, when the commands are executed by a computer, prompt the computer to carry out the computer-implemented method according to claim 1.
